(19) United States
(12) Patent Application Publication
(10) Pub. No.: US 2010/0321779 A1
(43) Pub. Date: Dec. 23, 2010

(54) POLARIZING PLATE PROTECTIVE FILM, POLARIZING PLATE AND RESISTIVE TOUCH PANEL

(75) Inventors: Tomoko Hane, Moriyama-shi (JP); Yoshinori Ishii, Moriyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GUNZE LIMITED, Ayabe-shi, Kyoto (JP)

(21) Appl. No.: 12/521,365

(22) PCT Filed: Dec. 27, 2007
(86) PCT No.: PCT/JP2007/075162

§ 371 Date: Jun. 26, 2009

(30) Foreign Application Priority Data
Dec. 27, 2006 (JP) 2006-351613

(51) Int. Cl. G02B 5/30; B32B 27/06

(52) U.S. Cl. 359/491; 359/485; 428/447

(57) ABSTRACT

The present invention provides a polarizing plate protective film obtained by forming a silane coupling agent layer on one side of a cyclic olefin-based resin film; a polarizing plate wherein the protective film is laminated on one side or both sides of a polarizer through the isocyanate-based silane coupling agent layer; and a resistive touch panel using the polarizing plate.

### TECHNICAL FIELD

The present invention relates to a polarizing plate protective film, a polarizing plate using the protective film, and a resistive touch panel using the polarizing plate.

### BACKGROUND ART

A polarizing plate is a member for use in image displays such as liquid crystal displays (LCDs), electroluminescence displays (ELDs), plasma displays, etc., and is produced by bonding a protective film to at least one side of a polarizer (polarizing film).

Heretofore, polarizing plates having a layered structure of TAC film/polarizer/TAC film, in which triacetyl cellulose (hereinafter sometimes referred to as “TAC”) films are used as protective films for the polarizer, have been widely known (see, for example, Patent Document 1).

However, to bond the TAC film and the polarizer, such polarizing plates generally require complicated production steps comprising carrying out a saponification treatment on the surface of the film, drying the film after treatment, and then bonding the film to the polarizer using an aqueous polyvinyl alcohol solution as an adhesive. Since TAC films have high water absorptivity and moisture permeability, they problematically cause in a short period of time a decrease in the polarization degree, hue change, light leakage under crossed nicols, major dimensional change of the polarizing plate, etc., under high temperature and high humidity conditions.

Despite attempts to utilize non-TAC films such as polycarbonates and acrylic polymers as a protective film for a polarizer, these films have not been used in practice due to the difficulty in bonding them to the polarizer.

Recently, a resistive low reflection touch panel having a polarizing plate on its surface has been used as an input device for a car navigation system or the like. However, the dimensional change of the polarizing plate under severe in-car environments (high temperature and high humidity conditions) may cause problems on the touch panel.

### Patent Document 1: Japanese Unexamined Patent Publication No. 2006-227604

### DISCLOSURE OF THE INVENTION

### Problems to be Solved by the Invention

The object of the present invention is to provide a polarizing plate protective film that is free from a decrease in the polarization degree, dimensional change, etc., even under high temperature and high humidity conditions; a polarizing plate using the film; and a resistive touch panel using the polarizing plate.

### Means for Solving the Problems

The present inventors conducted extensive research to achieve the above object. As a result, they found that a polarizing plate protective film obtained by forming a silane coupling agent layer on one side of a cyclic olefin-based resin film can easily adhere to a polarizer without complicated steps, and that a polarizing plate obtained using the protective film exhibits little decrease in the polarization degree and dimensional change even under high temperature and high humidity conditions.

In addition, demand has increased in recent years for a circularly polarizing plate formed by imparting the phase difference function to a polarizing plate to use the polarizing plate in LCD or touch panel applications. In view of this, the present inventors found that use of a retardation film obtained by stretching a cyclic olefin-based resin film can suitably achieve a polarizing plate for LCD or touch panel applications. In the LCD applications, the phase difference function is given to the polarizing plate for the purpose of optical compensation, and in the touch panel applications, for eliminating reflected light from the internal structure of a touch panel. Because of such effects, the polarizing plate of the present invention is suitably used for a so-called circularly polarizing touch panel. Conventionally, a retardation film has been laminated on a polarizing plate to attain such effects; however, the use of a retardation film as polarizing plate protective film will result in thickness and cost reduction.

The present invention has been accomplished based on these findings and by conducting further extensive studies.

The present invention provides the following polarizing plate protective film, polarizing plate using the film, and resistive touch panel using the polarizing plate.

1. A polarizing plate protective film obtained by forming a silane coupling agent layer on one side of a cyclic olefin-based resin film.

2. The polarizing plate protective film according to Item 1, wherein the silane coupling agent is an isocyanate-based silane coupling agent.

3. The polarizing plate protective film according to Item 1, wherein the cyclic olefin-based resin film is a retardation film to which the phase difference is imparted through stretching.

4. A polarizing plate comprising the protective film according to Item 1 and a polarizer, wherein the protective film is laminated on one side or both sides of a polarizer through the isocyanate-based silane coupling agent layer.

5. The polarizing plate according to Item 4, wherein the polarizer is a polarizing film obtained by adsorbing iodine or a dichromatic dye into a film comprising a polyvinyl alcohol-based polymer.

6. The polarizing plate according to Item 4, wherein the protective film is bonded to the polarizer using an aqueous adhesive comprising an aqueous polyvinyl alcohol solution.

7. A resistive touch panel using the polarizing plate according to Item 4.

### Polarizing Plate Protective Film

The polarizing plate protective film of the invention comprises a silane coupling agent layer formed on one side of a cyclic olefin-based resin film.

### Cyclic Olefin-Based Resin

Usable cyclic olefin-based resin films forming a protective film include those mainly comprising a cyclic olefin-based resin. Since cyclic olefin-based resin films have a low water absorption rate and water vapor permeability as well as a small photoelastic coefficient, they hardly exhibit a decrease in the polarization degree, hue change, light leakage under crossed nicols, etc., even under high temperature and high humidity conditions. Such films also have properties required of protective films for polarizing plates, such as high light transmittance.

Examples of cyclic olefin-based resins to be used in the invention include (a) random copolymers of α-olefin such as ethylene and propylene with cyclic olefin represented by the following formula (I) or (II); (b) ring-opening polymers or ring-opening copolymers of cyclic olefin represented by the following formula (I) or (II); (c) hydrides of (b) the ring-opening polymers or ring-opening copolymers; etc.

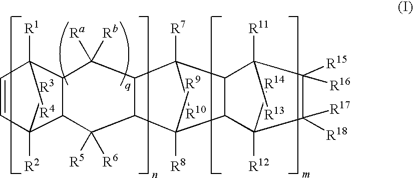

In the formula, n is 0 or 1, m is 0 or a positive integer, q is 0 or 1, R¹ to R¹⁸ and R^{a} and R^{b} are each independently a hydrogen atom, halogen atom, or hydrocarbon group optionally substituted with halogen, R¹⁵ to R¹⁸ taken together may form a single ring or multiple rings, the single ring or multiple rings may have a double bond, and R¹⁵ and R¹⁶, or R¹⁷ and R¹⁸ may form an alkylidene group.

Preferable examples of the cyclic olefin represented by the Formula (I) include norbornene, tetracyclododecene, etc.

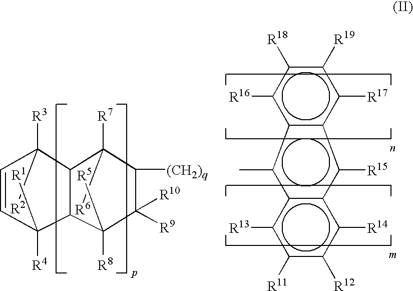

In the formula, p and q are each 0 or a positive integer; m and n are each 0, 1, or 2; R¹ to R¹⁹ are each independently a hydrogen atom, halogen atom, hydrocarbon group optionally substituted with halogen, or alkoxy group; and an R¹³-bonded carbon atom or R¹¹-bonded carbon atom may be combined with an R⁹ or R¹⁰-bonded carbon atom directly or via an alkylene group having 1 to 3 carbon atoms. Further, when n and m are 0, R¹⁵ and R¹² or R¹⁵ and R¹⁹ taken together may form a monocyclic ring or polycyclic aromatic ring.

Examples of cyclic olefin-based resins include derivatives in which cyclic olefin-based resins (a) to (c) are modified by α- or β-unsaturated carboxylic acid and/or derivatives thereof, styrene-based hydrocarbon, organosilicon compounds having an olefin unsaturated bond and a hydrolysable group, unsaturated epoxy monomer, etc.

Examples of usable cyclic olefin-based resins include commercially available products. Examples of such commercially available products include “ZEONOR” and “ZEONEX” (trade names, produced by Nippon Zeon Co., Ltd.); “ARTON” (trade name, produced by JSR Corporation); “APEL” (trade name, produced by Mitsui Chemicals, Inc.); “TOPAS” (trade name, produced by Topas Advanced Polymers, Inc.); etc.

The cyclic olefin-based resin to be used in the invention has a number average molecular weight, which is measured by the gel permeation chromatograph (GPC) method using chloroform as a solvent, of preferably about 30,000 to about 100,000, more preferably about 30,000 to about 80,000, and most preferably about 35,000 to about 65,000. At a number average molecular weight of less than 30,000, the resin has a reduced physical strength, whereas at over 100,000, the resin has poor handleability during formation.

The cyclic olefin-based resin to be used in the invention preferably has a water absorption rate (23° C./24 hours) of about 0.005 to about 0.1%. When the absorption rate exceeds 0.1%, the polarizing plate has poor durability-enhancing effects.

The cyclic olefin-based resin to be used in the invention usually has a refractive index of about 1.49 to about 1.55, and a light transmittance of about 93.0 to about 90.8%.

The cyclic olefin-based resin to be used in the invention usually has a photoelastic coefficient of about −50 to about +100 (×10⁻¹² Pa⁻¹).

Known additives such as ultraviolet absorbers, inorganic or organic antiblocking agents, slip agents, antistatic agents, stabilizers, etc. may be suitably added to the cyclic olefin-based resin.

There is no limitation on the method for forming a film from the cyclic olefin-based resin; for example, methods such as solution casting, extruding, and calendering can be employed.

Examples of solvents to be used in solution casting include alicyclic hydrocarbons such as cyclohexane and cyclohexene, and derivatives thereof; aromatic hydrocarbons such as toluene, xylene, and ethyl benzene, and derivatives thereof; etc.

The thickness of the cyclic olefin-based resin film is not limited insofar as the film can be used as the polarizing plate protective film. The film preferably has a thickness of about 5 to about 150 μm, more preferably about 10 to about 100 μm, and most preferably about 20 to about 60 μm. When the thickness is about less than 5 μm, the film has insufficient strength, resulting in handling difficulty.

### Silane Coupling Agent

The protective film of the invention includes a silane coupling agent layer that is formed on one side of a cyclic olefin-based resin film. In the silane coupling agent layer formed on the protective film, the curing reaction starts due to humidity; however, the reaction does not cause a chemical disorder on an iodine complex and a dichroic dye that are contained in a polarizer. On the contrary, the reaction advantageously results in improved adhesive strength with an aqueous adhesive such as an aqueous polyvinyl alcohol solution.

The silane coupling agent layer can be easily formed by applying a coating liquid obtained using the silane coupling agent that is, as required, diluted with an organic solvent and/or water; and drying the resulting product. Usable organic solvents include, for example, alcohols such as isopropyl alcohol and ethyl alcohol; and hydrocarbons such as cyclohexane. The concentration of the silane coupling agent in the coating liquid is preferably about 0.1 to about 100 volume %, and more preferably about 1 to about 5 volume %.

To improve the wetting properties and adhesive properties of the surface of the cyclic olefin-based resin film, surface modification treatments such as frame treatment, UV irradiation treatment, corona discharge treatment, plasma treatment, ITRO treatment, primer treatment, and chemical treatment may be carried out before the application of a silane coupling agent. The corona discharge treatment and UV irradiation treatment can be carried out under air, nitrogen gas, noble gas, or the like.

Examples of silane coupling agents include isocyanate-based silane coupling agents, amine-based silane coupling agents, etc.

Examples of amine-based silane coupling agents include 3-aminopropyl trimethoxysilane, 3-aminopropyltriethoxysilane, N-2-(aminoethyl)-3-aminopropyl methyl dimethoxysilane, N-2-(aminoethyl)-3-aminopropyl trimethoxysilane, N-2-(aminoethyl)-3-aminopropyltriethoxysilane, 3-triethoxy silyl N-(1,3-dimethylbutylidene) propylamine, N-phenyl-3-aminopropyl trimethoxysilane, etc.

Preferable examples of isocyanate-based silane coupling agents include those represented by the following formula (3).

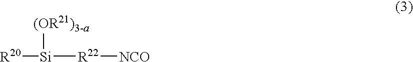

In the Formula (3), R²⁰ and R²¹ are each the same or different substituted or unsubstituted monovalent hydrocarbon groups, preferably those having 1 to 12 carbon atoms, and more preferably those having 1 to 6 carbon atoms. Examples of such monovalent hydrocarbon groups include alkyl groups such as methyl, ethyl, propyl, butyl, and hexyl; cycloalkyl groups such as cyclohexyl; alkenyl groups such as vinyl and allyl; aryl groups such as phenyl and tolyl; and groups in which one or more of the hydrogen atoms of the above groups are substituted by halogen atoms or a cyano group or the like, such as chloromethyl, trifluoropropyl and cyanoethyl; etc. Examples of R²⁰ and R²¹ include C₁₋₁₀ alkoxy-substituted C₁₋₁₀ alkyl groups such as methoxymethyl, ethoxymethyl, and methoxyethyl; C₇₋₂₀ aralkyl groups such as phenylethyl; etc. Examples of the hydrolyzable group represented by OR²¹ include C₁₋₁₀ alkoxy groups, C₂₋₁₀ alkenyloxy groups, C₆₋₁₆ aryloxy groups, C₁₋₁₀ alkoxy-substituted C₁₋₁₀ alkoxy groups, C₇₋₁₇ aralkyloxy groups, etc. Examples of R²² include alkylene groups such as methylene, ethylene, and propylene; arylene groups such as phenylene; and like C₁₋₁₀ bivalent hydrocarbon groups; and C₁₋₁₀ sulfur-substituted bivalent hydrocarbon groups. Further, a represents an integer of 0, 1, or 2.

Specific examples of isocyanate-based silane coupling agents are shown below. Examples The isocyanate-based silane coupling agent may be a hydrolysis-condensation product of each of the following examples, or a hydrolysis-condensation product of a silane mixture in which at least one of the following examples is mixed with (R²¹O)₂SiR²⁰₂, (R²¹O)₃SiR²⁰ or the like.

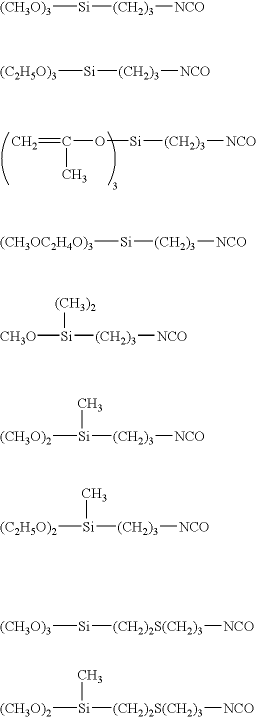

These silane coupling agents can be used singly or in a combination of two or more. Of such coupling agents, isocyanate-based silane coupling agents are particularly preferable since they are substantially free from a decrease in the polarization degree and hue change even under high temperature and high humidity conditions.

The application methods of the silane coupling agent are not limited as long as the agent can be applied on a cyclic olefin-based resin film. Examples of such methods include those using a gravure roll, wire bar, rag, die coater, comma coater, roll coater, Mayer bar, etc.

The thickness of the silane coupling agent layer to be applied is not limited as long as the function of the polarizing plate is not impaired and the layer can be bonded to the polarizer. The layer preferably has a thickness (when dried) of about 2 nm to about 1 μm. Drying after application is preferably carried out at about room temperature to about 100° C., for about 1 to 10 minutes.

The protective film of the present invention can be obtained by forming the silane coupling agent layer on one side of the cyclic olefin-based resin film according to the above method.

FIG. 1 is a view showing an example of a section of the protective film. In FIG. 1, the reference numeral 1 indicates a cyclic olefin-based resin film layer, and the reference numeral 2 indicates a silane coupling agent layer.

### Polarizing Plate

In the polarizing plate of the invention, the protective film(s) obtained by forming the silane coupling agent layer(s) on one side of a cyclic olefin-based resin film(s) is/are arranged on one side or both sides of a polarizer through the silane coupling agent layer(s).

Preferable examples of the polarizer (polarizing film) used for the polarizing plate of the invention include those obtained by uniaxially stretching and orienting a film made of a polyvinyl alcohol-based polymer (e.g., polyvinyl alcohol and partially formalized polyvinyl alcohol), absorbing iodine, performing an aqueous boric acid solution treatment, and drying under tension; and those obtained by immersing a film made of a polyvinyl alcohol polymer so that the iodine is absorbed, uniaxially stretching and orienting the film in an aqueous boric acid solution, and then drying the film under tension. Other usable polarizing films include those prepared in the same manner, using dichroic dyes such as azo-based, anthraquinone-based, and tetrazine-based dyes in place of iodine.

The thickness of the thus obtained polarizer (polarizing film) may be within the range that does not impair the function of the polarizer. The thickness is preferably about to about 100 μm. The polarizer preferably has a polarization degree of at least 95.0%, more preferably at least 99.0%, and most preferably at least 99.7%.

The polarizing plate of the invention can be easily prepared by bonding a protective film to one side or both sides of a polarizer so that the polarizing plate has a laminated structure of protective film/polarizer, or a laminated structure of protective film/polarizer/protective film.

As an adhesive, an aqueous adhesive comprising an aqueous polyvinyl alcohol solution is preferably used. The concentration of polyvinyl alcohol is preferably about 0.1 to about 5 wt %.

The polyvinyl alcohol of the adhesive is mainly composed of a resin obtained by carrying out a saponification treatment on a vinyl acetate resin. The polyvinyl alcohol preferably has a polymerization degree of about 1,000 to about 3,000 and a saponification degree of about at least 94%, and more preferably a polymerization degree of about 1,500 to about 3,000 and a saponification degree of about at least 98%. According to the purpose, the polyvinyl alcohol may be a copolymer in which a vinyl acetate is copolymerized with a small amount of other monomers such as acrylic acid, crotonic acid, itaconic acid, and the like; or the polyvinyl alcohol may be those modified by alkyl groups, epoxy groups, or the like.

The adhesive solution is preferably applied to a thickness (when dried) of about 0.01 to about 10 μm, more preferably about 0.02 to about 5 μm, and most preferably about 0.05 to about 3 μm. When the amount of the adhesive is too small, the desired adhesion strength is unlikely to be obtained, whereas when the amount of the adhesive is too large, it is unfavorable in view of cost.

The protective film(s) with adhesive being in the undried or semi-dried state is pressure-bonded to the polarizer, and then dried at room temperature to about 60° C. for about 5 to about 24 hours, thereby obtaining the polarizing plate of the invention.

FIG. 2 is a sectional view of the polarizing plate. In FIG. 2, the reference numeral 1 represents a cyclic olefin-based resin film layer, 2 a silane coupling agent layer, 3 an adhesive layer, and 4 a polarizer (polarizing film).

The polarizing plate of the invention can be suitably used as a polarizing plate for a general resistive low reflection touch panel.

FIG. 3 is a sectional view of a general resistive low reflection touch panel using a polarizer. In FIG. 3, the reference numeral 6 represents a polarizing plate, 7 ITO, 8 spacer, 9 adhesive, and 10 ITO glass.

The low reflection touch panel has the polarizing plate on its surface. Under the polarizing plate, a pair of transparent sheet-like members comprising resistance films composed of a transparent electrode such as ITO is arranged opposite each other at a certain interval. During operation, when a user pushes a certain point of the sheet-like member using a fingertip or pen, the resistance films corresponding to the pushed point are contacted each other to flow electricity. Based on the resistance value between the standard point and the contact point of the resistance film, the location of the pushed point is detected. Thereby, a coordinate for the contact point on the panel is determined, resulting in an appropriate interface function.

FIG. 3 describes as transparent sheet-like members a film and a glass in this order; however, the members may be a film and a film, a glass and a film, or a film and a film to which a support such as a glass or plastic plate is attached.

Low reflection touch panels with a polarizing plate are classified into linearly polarizing-type touch panels and circularly polarizing-type touch panels.

The film used as a base material of a resistance film in a linearly polarizing low reflection touch panel may be a film having optical isotropy, such as alicyclic polyolefin, thermoplastic norbornene resin, polyethersulfone (PES), polycarbonate (PC), etc.

The film used in a circularly polarizing low reflection touch panel is a retardation film that is produced by stretching the film having optical isotropy; or, in addition to the optical isotropic film, the retardation film may be laminated between a polarizing plate and an electrode film. In the circularly polarizing touch panel, the retardation film is also laminated on the back side of the glass.

Of the transparent sheet-like members, the upper member has a thickness of about 50 to about 500 μm, and is bonded to the polarizing plate via an adhesive with a thickness of about 10 to about 50 μm. The upper member is used as the upper structure of the low reflection touch panel.

### EFFECT OF THE INVENTION

According to the polarizing plate of the invention, the following remarkable effects can be obtained.

(1) The polarizing plate of the invention is substantially free from problems such as a decrease in the polarization degree, hue change, light leakage under crossed nicols, and dimensional change, even under high temperature and high humidity conditions. The present invention can achieve such effects presumably because the cyclic olefin-based resin film, which is included in a protective film, has a water vapor permeability of about as low as 2 g/m²/day, and a small dimensional change. Thus, the present polarizing plate can be suitably used as that for low reflection touch panels and LCDs of in-car navigators etc., which require severe environment resistance properties.

In contrast, in the widely known polarizing plates utilizing a TAC protective film, the film has a water vapor permeability of about as high as 300 g/m²/day and exhibits severe deterioration, such as a decrease in the polarization degree under high temperature and high humidity conditions. Therefore, these polarizing plates would cause problems such as a damaged contrast on a LCD of an in-car navigator or the like, a shape deformation on a low reflection touch panel of an in-car navigator or the like, etc.

(2) Based on the easy protective film preparation, the polarizing plate of the invention can be obtained by a simple method. Specifically, the present protective film can be prepared by only applying a silane coupling agent to a cyclic olefin-based resin film. Compared to TAC films, which are known protective films requiring saponification treatment and air-drying treatment, one-layer coating permits time-saving and the removal of the air-drying step allows for simple production. Thus, the polarizing plate of the invention can be prepared by a simple method, i.e., by only bonding the protective film to the polarizer.

### BRIEF DESCRIPTION OF THE DRAWINGS

FIG. 1 is a sectional view of the polarizing plate protective film.

FIG. 2 is a sectional view of the polarizing plate.

FIG. 3 is a sectional view of the resistive touch panel.

FIG. 4 is a sectional view explaining a resistive touch panel application test.

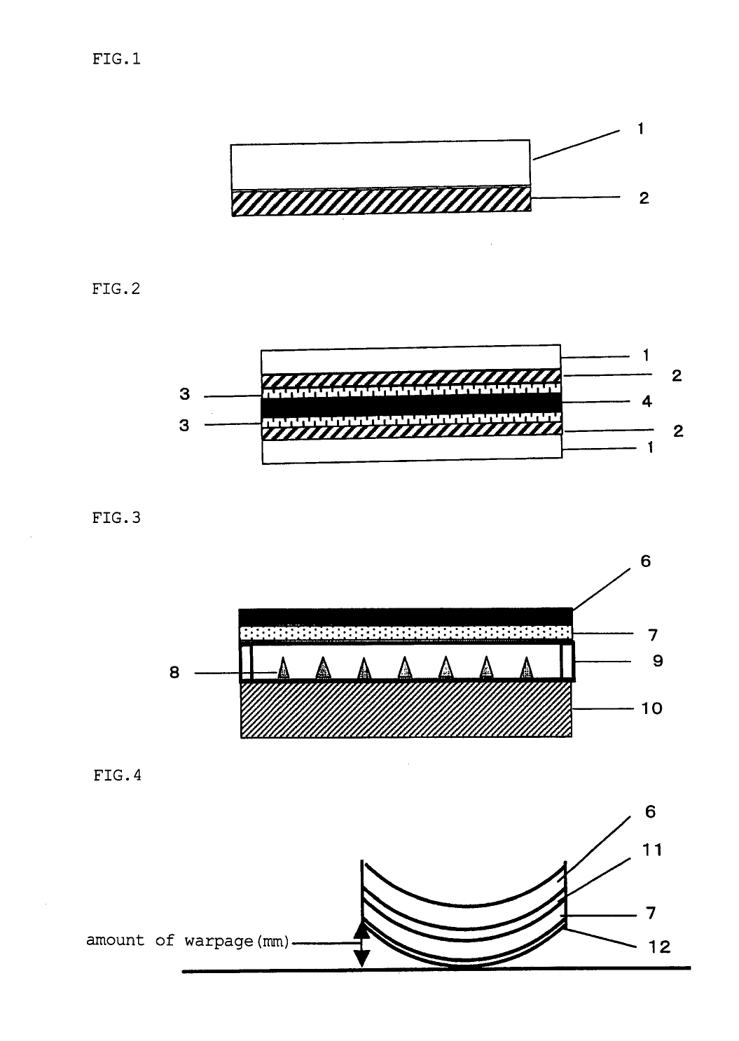

### EXPLANATION OF REFERENCE NUMERALS

1. Cyclic olefin resin film layer
2. Silane coupling agent layer
3. Adhesive layer
4. Polarizer
6. Polarizing plate
7. ITO film
8. Spacer
9. Adhesive
10. ITO glass
11. Adhesive
12. Electrode

### BEST MODE FOR CARRYING OUT THE INVENTION

The present invention is explained in detail below with reference to Production Examples, Examples, and Comparative Examples. In the Examples, the tests (the polarization degree of the polarizing plate, environmental test, dimensional change test, and resistive touch panel application test) were conducted as follows.

### The Polarization Degree of the Polarizing Plate

Two polarizing plates were arranged on top of one another so that the polarization axes were oriented in the same direction, and the light transmittance was measured continuously from a wavelength of 400 nm to 700 nm using a spectrophotometer. The average value of the light transmittance was defined as T₁. Two polarizing plates were then arranged on top of one another so that the polarization axes were perpendicular to one another, and the light transmittance was measured in the same manner. The resulting average value of the light transmittance was defined as T₂. Based on these values, the polarization degree was calculated using the following formula.

Polarization degree (%)={(T₁−T₂)/(T₁+T₂)}^{1/2}×100

### Environmental Test

The polarizing plate was allowed to stand for 40 hours in an atmosphere at a temperature of 80° C. and a relative humidity of 90% to thereby perform an environmental test. The polarization degree after the test was compared to the value before the test. The smaller the decrease in the polarization degree, the better the moisture heat resistance.

### Dimensional Change Test

The polarizing plate was cut to a size of 60 nun (in the orientation axis direction of the polyvinyl alcohol polarizer, i.e., the MD direction)×50 mm (in the transverse direction, i.e., the TD direction). The length of the resulting polarizing plate was measured in the TD and MD directions using an end measuring machine, and defined as the initial length L₁. The length after each of the environmental tests (temperature: 80° C., 24 hours; and temperature: 85° C., humidity: 90%, 24 hours) was measured in the same manner, and defined as the length after test L₂. Based on these values, the dimensional change was calculated using the following formula. The bigger the negative value of the dimensional change, the more the polarizing plate shrinks, and the bigger the positive value of the dimensional change, the more the polarizing plate expands.

Dimensional change (%)=[(L₂−L₁)/L₁]×100

### Resistive Touch Panel Application Test

Using an acrylic pressure-sensitive adhesive having a thickness of 25 μm, the polarizing plate was bonded to the film having an ITO transparent electrode on its surface, and then cut to a size of 70 mm (the orientation axial direction of the polyvinyl alcohol polarizer (MD direction))×70 mm (the vertical direction (TD direction)) to thereby obtain an upper structure of the resistive low reflection touch panel. The resulting sample was subjected to the environmental test (temperature: 85° C., humidity: 90%, 120 hours), and the amount of the warpage (mm) was measured as shown in FIG. 4 using a ruler. FIG. 4 is a sectional view demonstrating a resistive touch panel application test. In FIG. 4, the numeral reference 6 represents a polarizing plate, 7 ITO film, 11 adhesive, and 12 electrode. The warpage was measured at four corners of the sample, and the average of four values was defined as the amount of warpage (mm). In touch panel structure applications, the smaller the amount of warpage, the fewer defects are likely to occur, whereas the larger the amount of warpage, the more defects are likely to occur.

### Example 1

### Protective Film Preparation

Using a cyclic olefin-based resin (a copolymer of norbornene and ethylene, trade name “TOPAS6015”, produced by Topas Advanced Polymers, Inc., number average molecular weight: 45,800, glass transition point: 160° C.), the optical isotropic films having a thickness of 200 μm were obtained according to the T-die molding method under the following conditions (resin temperature: 270° C., draw roll temperature: 140° C.).

The resulting film was stretched in the width direction to two times its original size at 170° C. using a tenter clip-type transverse stretching machine, to thereby obtain a retardation film having a thickness of 100 μm and a retardation of 138 nm.

Subsequently, corona discharge treatment was performed on both sides of each of the resulting optical isotropic film and the retardation film under air at a treatment strength of 100 W/m²·min., giving the films a wetting tension of 500 μN/cm (23° C.).

Subsequently, a 1 wt % isopropyl alcohol solution of an isocyanate-based silane coupling agent (trade name “KBE-9007”, produced by Shin-Etsu Chemical Co., Ltd., 3-isocyanatepropyl triethoxysilane) was applied to one side of each of the surface-treated cyclic olefin-based resin films using a wire bar to a thickness (when dried) of 0.5 μm, and then allowed to stand in an oven at 100° C. for 10 minutes, followed by drying.

Thus, the polarizing plate protective film (1-1) (optical isotropic film) and the polarizing plate protective film (1-2) (retardation film), both having a silane coupling agent layer on one side of the cyclic olefin-based resin film, were obtained. The protective film (1-1) has a water vapor permeability of 2 g/m²·24 hr and a retardation of 1.0 nm. The protective film (1-2) has a water vapor permeability of 2 g/m²·24 hr and a retardation of 138 nm.

### Production Example 1

### Polarizer Preparation

A polyvinyl alcohol film having a thickness of 75 μm (trade name “Kuraray vinylon film VF-9X75R”, produced by Kuraray Co., Ltd.) was immersed for 5 minutes in an aqueous solution comprising 5,000 parts by weight of water, 35 parts by weight of iodine, and 525 parts by weight of potassium iodide, to adsorb iodine. Subsequently, the film was uniaxially stretched to about 4.4 times its original size in the longitudinal direction in a 4 wt % boric acid aqueous solution at 45° C. The film was then dried under tension to thereby obtain a polarizer (polarizing film) having a thickness of 17 μm.

### Example 2

### Polarizing Plate Preparation

A 1.5 wt % aqueous solution of polyvinyl alcohol having an average polymerization degree of 1,800 and a saponification degree of 99% was used as an adhesive. The adhesive was applied to both sides of the polarizing film obtained in Production Example 1 to a thickness of 1 μm (when dried). While the adhesive was in an undried state, the polarizing plate protective films (1-1) obtained in Example 1 were laminated on both sides of the polarizing film through the silane coupling agent coating surfaces. The resulting structure was then secured between a rubber roller and a metal roller (the rubber roller having a diameter of 20.0 mm, the metal roller having a diameter of 350 mm, and the line pressure being 10 kg/cm), and allowed to stand in an oven at 40° C. for 24 hours, followed by drying.

Further, the polarizing plate protective film (1-1) obtained in Example 1 was applied to one side of the polarizing film obtained in Production Example 1 through the silane coupling agent layer, and the polarizing plate protective film (1-2) obtained in Example 1 was applied to the other side of the polarizing film through the silane coupling agent layer in the same manner. In this case, the protective film (1-2) was arranged to give the retardation axis an angle of 45° with respect to the polarization axis of the polarizer.

Thus, the polarizing plate (1) having a layered structure of protective film (1-1)/polarizing film/protective film (1-1), and the polarizing plate (2) having a layered structure of protective film (1-1)/polarizing film/protective film (1-2) were obtained.

The resulting polarizing plate (1) has a polarization degree of 99.8%. The polarization degree after the environmental test (temperature: 80° C., humidity: 90%, 40 hours) was also 99.8%. Accordingly, no decrease in the polarization degree was observed from the value before the test, demonstrating excellent moisture heat resistance.

As for the resulting polarizing plate (2), no decrease was observed in the polarization degree after the environmental test (temperature: 80° C., humidity: 90%, 40 hours), demonstrating excellent moisture heat resistance.

### Example 3

The dimensional change of the polarizing plate (2) obtained in Example 2 was measured under high temperature conditions, and high temperature and high humidity conditions. The dimensional change under the condition of a high temperature of 80° C. for 24 hours was −0.28% in the MD direction and −0.12% in the TD direction. The dimensional change under the condition of a high temperature of 85° C. and a high humidity of 90% for 24 hours was 0.07% in the MD direction, and 0.12% in the TD direction. Almost no dimensional change was observed.

Subsequently, a resistive touch panel application test was carried out on the polarizing plate (2). As a film having an ITO transparent electrode on its surface, a siloxane cross-linking acrylic silicone resin film (thickness: 200 μm) on whose surface an ITO transparent electrode (thickness: 30 nm, surface resistance value: 250 Ω/sq.) was formed using a sputtering method was employed. The amount of warpage in the upper structure obtained after the environmental test (temperature: 85° C., humidity: 90%, 120 hours) was as small as 1.2 mm. The results reveal that the use of the polarizing plate results in a resistive low reflection touch panel excellent in environmental durability.

### Comparative Example 1

The comparative polarizing plate was obtained in the same manner as in Example 2, except that a TAC film (trade name “TDY80UL”, produced by Fuji Photo Film Co., Ltd.) was applied in place of the polarizing plate protective film obtained in Example 1 on both sides of the polarizing film. The resulting polarizing plate has a polarization degree of 99.8% and a surface pencil hardness of H. The polarization degree after the environmental test (temperature: 80° C., humidity: 90%, 40 hours) was 94.1%. A significant decrease in the polymerization degree was observed after the test, demonstrating poor moisture heat resistance.

### Comparative Example 2

The procedure of Example 1 was repeated using a cyclic olefin-based resin film that had been subjected to corona discharge treatment to provide a water contact angle of 37° (23° C.), but without applying a silane coupling agent. The comparative polarizer plate protective film was thus obtained.

Subsequently, following the procedure of Example 2, an attempt was made to bond the protective film to both sides of the polarizer (polarizing film) using as an adhesive a 1.5 wt % aqueous polyvinyl alcohol solution having an average polymerization degree of 1,800 and a saponification degree of 99%, so as to provide an adhesive layer 1 μm in thickness (when dried). The bonding was conducted while the adhesive was wet; however, the film was not able to bond to the polarizer. Accordingly, no polarizing plate was obtained.

### Comparison Example 3

The dimensional change of a commercially available polarizing plate (trade name “SKN-18243TL” produced by Polatechno Co., Ltd.) in which a TAC film was used as a protective film was measured under high temperature conditions, and high temperature and high humidity conditions. The dimensional change under the condition of a high temperature of 80° C. for 24 hours was ˜0.61% in the MD direction and −0.34% in the TD direction. The dimensional change under the condition of a high temperature of 85° C. and a high humidity of 90% for 24 hours was −2.44% in the MD direction, and 1.27% in the TD direction. A significant dimensional change was observed.

Subsequently, a resistive touch panel application test was carried out on the aforementioned polarizing plate. The film having an ITO transparent electrode on its surface was as used in Example 3. The amount of warpage in the upper structure obtained after the environmental test (temperature: 85° C., humidity: 90%, 120 hours) was as large as 13.3 mm. The results reveal that the use of the polarizing plate obtained in Example 2 provides a touch panel with higher durability under severe environments.

1. A polarizing plate protective film obtained by forming a silane coupling agent layer on one side of a cyclic olefin-based resin film.

2. The polarizing plate protective film according to claim 1, wherein the silane coupling agent is an isocyanate-based silane coupling agent.

3. The polarizing plate protective film according to claim 1, wherein the cyclic olefin-based resin film is a retardation film to which the phase difference is imparted through stretching.

4. A polarizing plate comprising the protective film according to claim 1 and a polarizer, wherein the protective film is laminated on one side or both sides of a polarizer through the isocyanate-based silane coupling agent layer.

5. The polarizing plate according to claim 4, wherein the polarizer is a polarizing film obtained by adsorbing iodine or a dichromatic dye into a film comprising a polyvinyl alcohol-based polymer.

6. The polarizing plate according to claim 4, wherein the protective film is bonded to the polarizer using an aqueous adhesive comprising an aqueous polyvinyl alcohol solution.

7. A resistive touch panel using the polarizing plate according to claim 4.
